(19) United States
(12) Patent Application Publication
(10) Pub. No.: US 2005/0120564 A1
(43) Pub. Date: Jun. 9, 2005

(54) Scraper

(76) Inventor: Tsai-Lian Chen Lin, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 10/730,822

(22) Filed: Dec. 8, 2003

(51) Int. Cl. B26B 3/00

(52) U.S. Cl. 30/169

(57) ABSTRACT

A scraper comprises a main body and a blade. When a clasp on a locking cover locks with a clasp seat on the main body, the clasp of the locking cover can be completely received in the clasp seat of the main body. Thus, a user can scrape smoothly. In addition, a recess is formed on a handle portion of the main body to receive the blade.

### BACKGROUND OF THE INVENTION

1. Field of the Invention

The present invention relates to a scraper, and more particularly to an improved scraper capable of scraping impurities off the glass or ceramic tile, which also can be used to cut the tape.

2. Description of the Prior Arts

A conventional scraper normally has a main body integrally made by method of ejection molding. As shown in FIG. 1, a blade 20 is put on a compression surface 11 of the main body 10 of a scraper, and then clasp 144 is used to engage a clasp seat 113 of the main body 10, and thus the blade 20 can be hold by a cover 14 of the main body 10. This conventional scraper has been widely used, however, there are still some defects will appear in operation and need to be improved as follows:

First, when the clasp 144 of the cover 14 is engaged with the clasp seat 113 of the main body 10, the clasp 144 partially protrudes out of the clasp seat 113 of the main body 10, such that, in operation, the user has to hold the main body 10 and make the blade 20 contact a surface to be scraped with higher angle, as a result, it is difficult for the user to scrape smoothly, and thus the surface will probably be scratched.

Second, when it is being used, the blade 20 should be turned to make its sharp edge extend toward the main body 10 of the scraper, however, if the user forgets to do so, the sharp edge will probably hurt the user.

The present invention has arisen to mitigate and/or obviate the afore-described disadvantages of the conventional scraper.

### SUMMARY OF THE INVENTION

The primary object of the present invention is to provide a scraper, when the clasp of the locking cover is engaged with the clasp seat, the clasp can be fully received in the clasp seat of the main body. By such arrangements, the blade is able to contact a surface to be scraped with lower angle, and thus the surface can be scraped smoothly and cleanly.

The secondary object of the present invention is to provide a scraper, wherein a recess is defined on a handle portion of the main body of the scraper for the reception of the blade, such that the blade can be received in recess after operation, so as to safeguard the user from being hurt.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a side view of a conventional scraper;

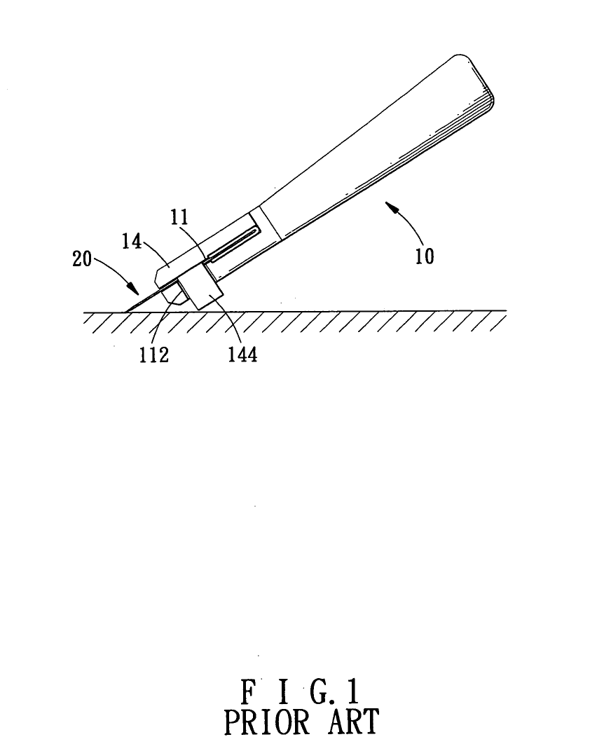

FIG. 2 is an exploded view of a scraper in accordance with the present invention;

FIG. 3 is a side assembly view of the scraper in accordance with the present invention;

FIG. 4 is a partial exploded view of a scraper in accordance with the present invention, wherein in a recess of the scraper is defined with a spring;

FIG. 5 is an operational view of the scraper in FIG. 3.

### DETAILED DESCRIPTION OF THE PREFERRED EMBODIMENTS

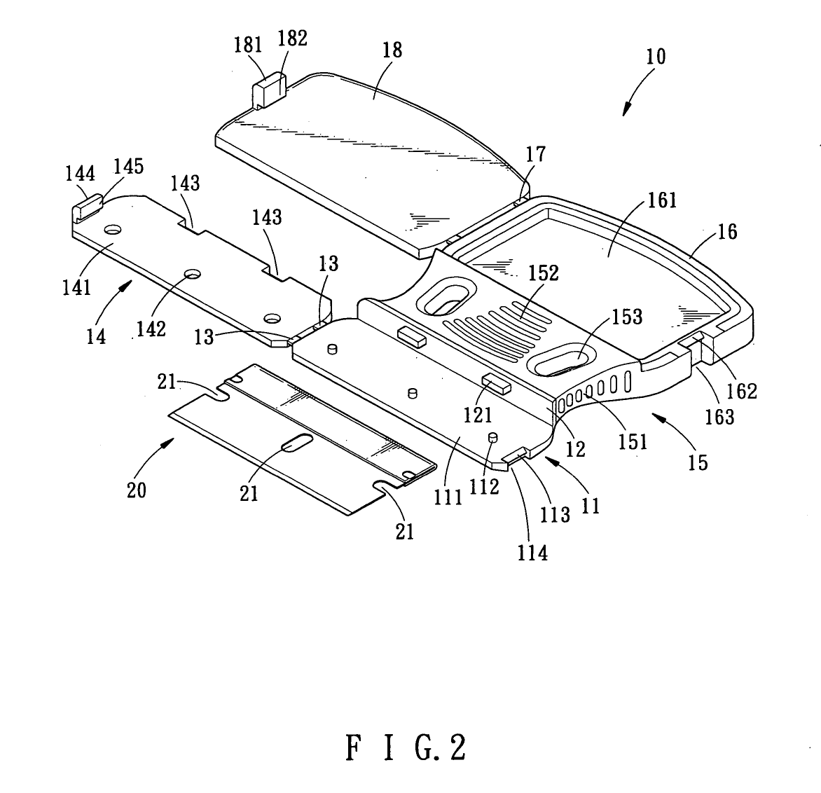

Referring to FIG. 2, a scraper in accordance with a preferred embodiment of the present invention generally comprises a main body 10 and a blade 20.

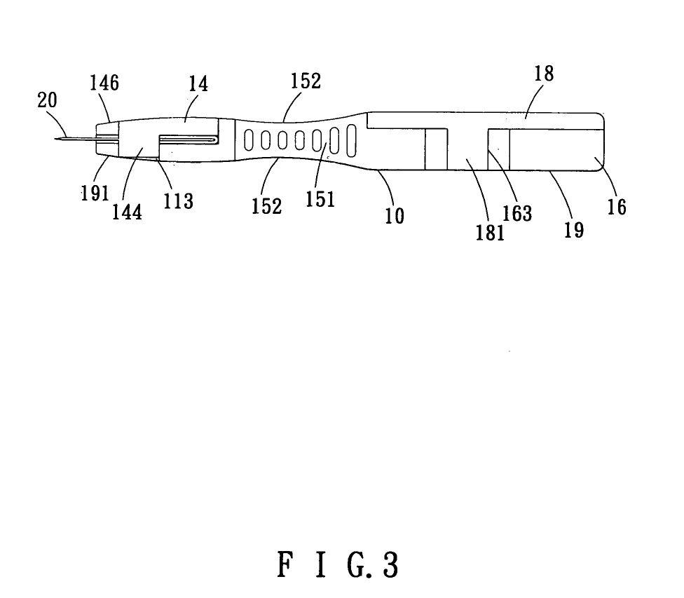

The main body 10 includes head portion 11, neck portion 15 and handle portion 16. Wherein the head portion 11 is defined with a compression surface 111 at a front edge thereof, on the compression surface 111 is formed with three locating legs 112. And a clasp seat 113 is provided at a side of the compression surface 111 and forms a receiving space 114 with respect to a bottom surface 19 of the main body of the scraper. A wall 12 is adjacent to the compression surface 111 and provided with two protrusive blocks 121. At another side of the compression surface 111 is provided with an arbitrarily bendable connecting portion 13 which is connected with a locking cover 14. The locking cover 14 has a compression side 141, and on which is formed with three locating grooves 142 in corresponding to the locating legs 112 on the main body 10. The compression side 141 is formed with a pair of gaps 143 which correspond to the protrusive blocks 121 of the main body 10. The locking cover 14 is further provided at another side thereof with a clasp 144 which is defined with a locking block 145 at a side thereof. At a front edge of the locking cover 14 an arc surface 146 is formed as shown in FIG. 3. Along the connecting portion 13, the locking cover 14 can be folded up against the compression surface 111 of the head portion 11, and the clasp 144 of the locking cover 14 is engaged with the clasp seat 113 of the head portion 11 in a manner that the locking block 145 of the clasp 144 is received in the receiving space 114 of the clasp seat 113. The neck portion 15 is connected with the head portion 11 and the handle 16 of the main body 10. At the left and right sides of the neck portion 15 is formed with a concave surface 151, and at a lower and an upper surfaces of the neck portion 15 is formed with a sunken surface 152 respectively. The concave surface 151 and the sunken surface 152 of the main body of the scraper are embossed with anti-skid devices for improving grip. The neck portion 15 is further defined with through holes 153 on a surface thereof. On the handle portion 16 a recess 161 is defined, and at a side of the handle portion 16 is formed with a locking seat 162 that forms a receiving space 163 relative to the bottom surface 19 of the main body 10. At another side of the handle portion 16 an arbitrarily bendable linking portion 17 is formed and connected with a side of a cover 18. At another side of the cover 18 is provided with a retainer 181 that has a locking block 182 formed at a side thereof. Along the linking portion 17, the cover 18 can be folded up against the handle portion 16 and fixed to the locking seat 162 of the handle 16 in a manner that the locking block 182 of the retainer 181 is received in the receiving space 163 of the locking seat 162. In addition, an arc surface 191 is formed at a front edge of the bottom surface 19 of the main body 10 of the scraper.

The blade 20, defined with locating holes 22 at a center and both sides thereof, is to be put on the compression surface 111 of the main body 10 in a manner that the respective locating legs 111 insert through the respective locating holes 21 of the blade 20.

Referring further to FIGS. 2 and 3, when the clasp 144 of the locking cover 14 engages the clasp seat 113 of the main body 10, the locking block 145 of the locking cover 14 is fully received in the receiving space 114 of the clasp seat 113, in this way, the clasp 144 will not protrude out of the clasp seat 113 of the main body 10 of the scraper. Furthermore, at the front edge of the bottom surface 19 of the main body 10 and the locking cover 14 are provided with arc surfaces 191 and 145. Thus, the user is able to scrape smoothly with the main body 10.

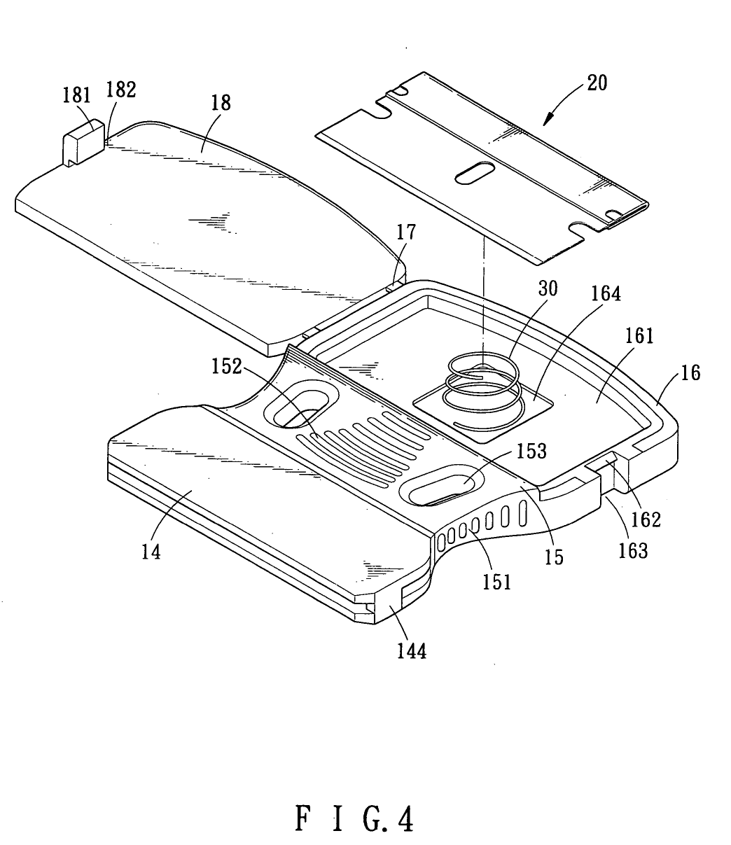

On the handle portion 16 of the main body 10 a recess 161 is formed thereof for the reception of the blade 20, so as to prevent the user from being cut. Furthermore, a shallow groove 164 can be formed at the bottom of the recess 161, in which a spring 30 is provided, such that it is convenient for the user to take the blade 20 out of the recess 161 as shown in FIG. 4.

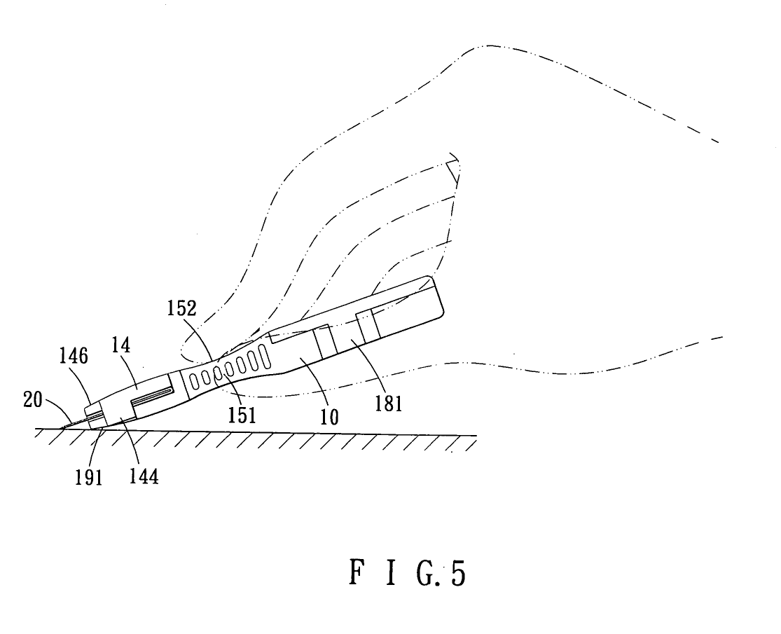

At the left and right sides of the neck portion 15 of the main body 10 is formed with a concave surface 151, and at a lower and an upper surfaces of the neck portion 15 is formed with a sunken surface 152 respectively, as shown in FIG. 5, such that the user can more firmly hold the main body 10 of the scraper. The through hole 153 in the neck portion 15 enables the scraper to be stringed together with other tools or keys.

While we have shown and described various embodiments in accordance with the present invention, it should be clear to those skilled in the art that further embodiments may be made without departing from the scope of the present invention.

1. A scraper generally comprising:
a main body having a compression surface, on the compression surface being formed with locating legs, a clasp seat being provided at a side of the compression surface and at another side of the compression surface being provided with an arbitrarily bendable connecting portion connected with a locking cover, the locking cover being formed with locating grooves in corresponding to the locating legs on the main body, the locking cover being further provided with a clasp, along the connecting portion, the locking cover can be folded up against the compression surface of a head portion of the scraper, and the locking cover to be engaged with the clasp seat of the main body of the scraper, a recess being defined in the main body and a locking seat formed at a side of the recess, at another side of the recess an arbitrarily bendable linking portion being formed and connected with a cover, along the linking portion, the cover can be folded up against the recess of the main body, such that the cover is locked to the locking seat;
a blade defined with locating holes in corresponding to the locating legs of the main body of the scraper, in operation, the locating legs of the blade to be inserted through the respective locating holes, and the blade can be received in the recess of the main body of the scraper when it is not being used.

2. The scraper as claimed in claim 1, wherein a shallow groove is defined at a bottom of the recess, and a spring is provided in the groove so as to enable user to take out the blade easily.

3. The scraper as claimed in claim 1, wherein the main body of the scraper is formed with a concave surface at a left side and a right side thereof, and at a lower surface and an upper surface of the main body is respectively formed with a sunken surface, the concave surface and the sunken surface of the main body of the scraper are embossed with anti-skid devices for improving grip.

4. The scraper as claimed in claim 1, wherein an arc surface is respectively formed at a front edge of a bottom surface of the main body and a front edge of the locking cover, and thus, the blade is able to contact a surface to be operated at lower angle, such that no vibration will be caused during operation.
